(19) United States
(12) Patent Application Publication
(10) Pub. No.: US 2024/0402760 A1
(43) Pub. Date: Dec. 5, 2024

(54) Devices With Detachable Headbands

(71) Applicant: Apple Inc., Cupertino, CA (US)

(72) Inventors: Ryan M David, San Francisco, CA (US); Yuhao Pan, Sunnyvale, CA (US); Evan A Cernokus, Campbell, CA (US); Erin M Bosch, San Jose, CA (US); Benjamin A Stevenson, Oakland, CA (US); Paul J Biestek, Kenmore, WA (US); Paul X Wang, Cupertino, CA (US); Katherine E Christensen, Shoreline, WA (US); Michael Wu, San Jose, CA (US); James T Smith, Issaquah, WA (US); Jered Singleton, Bainbridge Island, WA (US); Venkata Narayana Murthy Arelekatti, Mountain View, CA (US); Chad J Miller, Oakland, CA (US)

(21) Appl. No.: 18/638,537

(22) Filed: Apr. 17, 2024

Related U.S. Application Data
(60) Provisional application No. 63/627,426, filed on Jan. 31, 2024.
(60) Provisional application No. 63/619,801, filed on Jan. 11, 2024.
(60) Provisional application No. 63/505,657, filed on Jun. 1, 2023.

(51) Int. Cl. G06F 1/16

(52) U.S. Cl. CPC G06F 1/163

(57) ABSTRACT

A head-mounted device may have a head-mounted housing containing rear-facing displays that display images for a user when the head-mounted housing is worn by the user. The head-mounted device housing may have housing structures such as elongated housing members with protruding posts. Multiple headbands may be removably coupled to the head-mounted device housing at the protruding posts. A first headband may have a strap with openings configured to receive the posts. Releasable latches may be provided to allow selective engagement and disengagement between the headband and the housing. A second headband may be coupled to the posts between the housing members and the first headband. Alternatively, the first headband may surround the post, and the second headband may be coupled to the post through the opening in the first headband. One or more hair guards and/or one or more keeper loops may be incorporated between the headbands.

This application claims the benefit of U.S. provisional patent application No. 63/627,426, filed Jan. 31, 2024, U.S. provisional patent application No. 63/619,801, filed Jan. 11, 2024, and U.S. provisional patent application No. 63/505,657, filed Jun. 1, 2023, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have a head-mounted housing. The head-mounted housing may have displays that display images for a user when the head-mounted housing is worn by the user. Multiple headbands may be removably coupled to the head-mounted device housing at the protruding posts. When the user is wearing the head-mounted device, the headbands may help hold the head-mounted housing against the face of the user. The headbands may be removed and replaced with a different headband when desired.

The head-mounted device may have housing structures such as elongated housing members with protruding posts. A first headband (e.g., a behind-head band) may have a strap with openings configured to receive the posts. Releasable latches may be provided to allow selective engagement and disengagement between the headband and the housing.

A second headband (e.g., an overhead band) may be coupled to the posts between the housing members and the first headband. Alternatively, the first headband may surround the post, and the second headband may be coupled to the post through the opening in the first headband. The second headband may be attached to the posts with additional posts, with magnets, with a twist-to-lock system, or may be between the posts and the first headband, thereby being fixed to the member, as examples.

A hair guard may be incorporated between the first and second headbands to prevent hair of the user from entering the gap between the first and second headbands. The hair guard may have a curvature that matches a curvature of the first headband and/or the second headband.

One or more keeper loops may be incorporated into the headbands. The keeper loops may be coupled to multiple portions of the headbands and may maintain the position of the portions of the headbands relative to one another. For example, a keeper loop may be formed integrally with a temple webbing in a headband.

The headbands may include a woven fabric portion surrounded by a webbing. The webbing may have rounded corners at an edge of the woven fabric portion, and the webbing may appear seamless to the naked eye.

One or more hook and loop fasteners may be coupled to portions of the headbands to allow for adjustments to the headbands and to maintain the position of the headbands after they has been adjusted. Pull tabs may be coupled to surfaces of the headbands opposite the hook and loop fasteners to allow for the adjustments.

### BRIEF DESCRIPTION OF THE DRAWINGS

FIG. 1 is a side view of an illustrative electronic device such as a head-mounted display device with a detachable headband in accordance with some embodiments.

FIG. 2 is a perspective view of an illustrative headband with a post that couples to a post on a head-mounted structure in accordance with some embodiments.

FIG. 3 is a cross-sectional side view of an illustrative headband with a post that couples to a post on a head-mounted structure in accordance with some embodiments.

FIG. 4 is a cross-sectional side view of an illustrative detachable headband with a release tab in accordance with some embodiments.

FIG. 5 is a perspective view of an illustrative headband with a magnet that couples to a post on a head-mounted structure in accordance with some embodiments.

FIG. 6 is a cross-sectional side view of an illustrative headband with a magnet that couples to a post on a head-mounted structure in accordance with some embodiments.

FIG. 7 is a cross-sectional side view of an illustrative headband with a magnet and a protrusion that couples to a post with a recess on a head-mounted structure in accordance with some embodiments.

FIG. 8 is a perspective view of an illustrative headband that has portions that wrap around a head-mounted support structure to attach to the support structure in accordance with some embodiments.

FIG. 9 is a perspective view of an illustrative headband that attaches to a head-mounted support structure with a lug and socket system in accordance with some embodiments.

FIG. 10 is a cross-sectional side view of two illustrative headbands that attach to a head-mounted support structure with latches in accordance with some embodiments

FIG. 11 is a cross-sectional side view of two illustrative headbands, one of which attaches to a head-mounted support structure with a latch, and one of which attaches to the head-mounted support structure with a protrusion, in accordance with some embodiments

FIG. 12 is a diagram of an illustrative headband that attaches to a head-mounted support structure with a twist-to-lock system in accordance with some embodiments.

FIG. 13 is a perspective view of an illustrative headband that has an opening to surround a post of a head-mounted support structure in accordance with some embodiments.

FIG. 14 is a cross-sectional side view of an illustrative headband that has an opening to surround a post of a head-mounted support structure in accordance with some embodiments.

FIGS. 15A and 15B are perspective views of an illustrative post with an extendable magnet in accordance with some embodiments.

FIG. 16 is a perspective view of an illustrative headband with an opening to receive a magnet and couple to a head-mounted support structure in accordance with some embodiments.

FIGS. 17A and 17B are cross-sectional side views of an illustrative headband engaging with an extendable magnet of a post in accordance with some embodiments.

FIGS. 18A-18C are perspective views of illustrative hair guards in accordance with some embodiments.

FIG. 19 is a perspective view of an illustrative hair guard attached to a headband in accordance with some embodiments.

FIG. 20 is a side view of an illustrative hair guard attached to a headband in accordance with some embodiments.

FIG. 21 is a side view of an illustrative headband that includes a keeper loop to maintain the position of portions of the headband in accordance with some embodiments.

FIG. 22 is a perspective view of an illustrative headband that includes a keeper loop to maintain the position of portions of the headband in accordance with some embodiments.

FIG. 23 is a side view of an illustrative headband that includes a keeper loop and an integrated adjuster loop in accordance with some embodiments.

FIG. 24 is an illustrative front view of an edge of a headband portion in accordance with some embodiments.

FIG. 25 is a top view of an illustrative headband portion with a seam that is invisible to a naked eye in accordance with some embodiments.

FIGS. 26A-26E are views of illustrative hook and loop fasteners that may be coupled to a headband portion in accordance with some embodiments.

FIG. 27 is a side view of an illustrative headband portion with a pull tab in accordance with some embodiments.

FIG. 28 is a perspective view of an illustrative headband system having one or more adjuster loops, keeper loops, and pull tabs in accordance with some embodiments.

FIG. 29 is a perspective view of an illustrative upper headband having temple portions in accordance with some embodiments.

FIGS. 30A and 30B are perspective views of illustrative temple portions that may be incorporated in a headband in accordance with some embodiments.

FIG. 31 is a perspective view of an illustrative headband system having an upper headband with temple portions attached to support members and a lower headband coupled to the temple portions in accordance with some embodiments.

### DETAILED DESCRIPTION

Head-mounted devices include head-mounted support structures that allow the devices to be worn on the heads of users. The head-mounted support structures may include device housings that enclose components such as displays. The displays may be used for presenting a user with visual content. The head-mounted support structures for a head-mounted device may also include headbands and other structures that help hold a device housing on the face of a user. The headbands of a head-mounted device may be removable. This allows users to swap different headbands into use to accommodate different head sizes and/or to update the style of headband being used.

In some embodiments, it may be desirable to attach multiple headbands to a head-mounted device. For example, one detachable headband may extend from the head-mounted support structures around the back of a user's head when worn, and another detachable headband may extend over the user's head. The user of two (or more) headbands may hold the head-mounted device against the user's face and prevent excessive pressure on the face when the device is worn. Both headbands may attach and detach from the same portion of the head-mounted support structures.

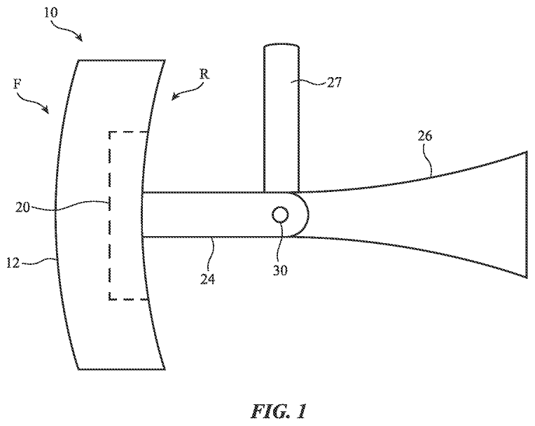

FIG. 1 is a side view of an illustrative head-mounted electronic device with multiple detectable headbands. As shown in FIG. 1, head-mounted device 10 may include head-mounted housing 12 (sometimes referred to as a main housing, main housing unit, head-mounted support structure, main housing portion, etc.). Housing 12 may have walls or other structures that separate an interior housing region from an exterior region surrounding housing 12. For example, housing 12 may have walls formed from polymer, glass, metal, and/or other materials. Electrical and optical components may be mounted in housing 12. These components may include components such as integrated circuits, sensors, control circuitry, input-output devices, etc.

To present a user with images for viewing from eye boxes (e.g., eye boxes in which the user's eyes are located when device 10 is being worn on the users' head), device 10 may include displays and lenses. These components may be mounted in optical modules 20 that face towards rear R of device 10 or may be mounted in other supporting structures in housing 12 to form respective left and right optical systems. There may be, for example, a left display for presenting an image through a left lens to a user's left eye in a left eye box and a right display for presenting an image to a user's right eye in a right eye box.

If desired, housing 12 may have forward-facing components such as cameras and other sensors on front F for gathering sensor measurements and other input and may have a soft cushion on opposing rear R. Rear R may have openings that allow the user to view images from left and right optical modules 20 (e.g., when rear R is resting on the front of the user's head).

Device 10 may have strap such as headband 26 and over-the-head headband 27 to help hold housing 12 on the user's head. Headbands 26 and 27 may have a fixed length or may be adjustable. Headbands 26 and 27 may have first and second ends coupled, respectively, to the left and right sides of housing 12. In the example of FIG. 1, coupling members 24, which serve as extensions of housing 12, are provided on the left and right sides of housing 12. Members 24 may be formed from rigid materials such as rigid polymer and/or other materials and may contain sensors, buttons, speakers, and other electrical components. Hinges and/or other mechanisms may be used to couple members 24 to housing 12 or members 24 may be formed as integral portions of a main housing unit.

The ends of headbands 26 and 27 may have coupling mechanisms such as openings, magnets, second posts, or other structures configured to attach to posts 30 (pins) or other protrusions on members 24 or other housing structures. In an illustrative configuration, these posts face inwardly towards the user's head and are not visible to people in the vicinity of device 10 when device 10 is being worn by the user. Releasable latch mechanisms can be used to help secure the ends of headband 26 and/or headband 27 to member 24. For example, a first detachable latch may be used to removably couple the left end of headband 26 to a left post in a left member 24 on a left side of housing 12 and a second detachable latch may be used to removably couple the right end of headband 26 to a right post in a right member 24 on a right side of housing 12. Third and fourth detachable latches may couple respective left and right ends of headband 27 to the left and right posts. Alternatively or additionally, headband 27 may be attached to the posts between member 24 and headband 26 to keep headband 27 attached to member 24 when headband 26 is attached, and/or may use another structures, such as a magnetic structure or additional post, to attach to posts 30.

If desired, a user may flip the headband over so that the first detachable latch removable couples the end of headband 26 that was previously coupled to the left post to the right post and so that the second detachable latch removably couples the end of headband 26 that was previously coupled to the right post to the left post (e.g., the user may flip the left and right sides of the band without flipping the band inside out). Headband 27 also may have reversible ends, if desired. A user may open and close the latches when housing 12 is being worn or, in an illustrative configuration that is sometimes described herein as an example, a user may open and close the latches when housing 12 is not being worn.

The use of latch-based coupling mechanisms, magnetic structures, and/or or other mechanisms in device 10 may help allow a user to removably attach headbands 26 and 27 to members 24 and thereby removably attach headbands 26 and 27 to housing 12. Members 24 may have elongated shapes of the type shown in FIG. 1 and/or other suitable shapes and may sometimes be referred to as rigid straps, rigid coupling members, power straps, head-mounted device housing structures, elongated head-mounted device housing members, elongated housing structures, elongated housing members, or head-mounted device housing members (as examples).

Headbands 26 and 27 may be straps with soft flexible portions and/or rigid portions. As an example, a central portion of headband 26 and/or headband 27 may be formed from stretchable fabric. The central portions of headband 26 and/or headband 27 may have internal stiffening members, external fabric coverings and or other covering layers, strips of strengthening fabric, stretchable fabric portions (e.g., stretchable knit fabric), cosmetic coverings, and/or other headband structures.

Left and right end portions of headband 26 and/or headband 27 may be coupled to opposing ends of this central portion. The left and right end portions may, as an example, have stiffening structures (e.g., the left and right end portions may be stiffer than the central stretchable portion). Other types of configuration may be used for headband 26, if desired (e.g., arrangements with adjustable tensioning cables, etc.).

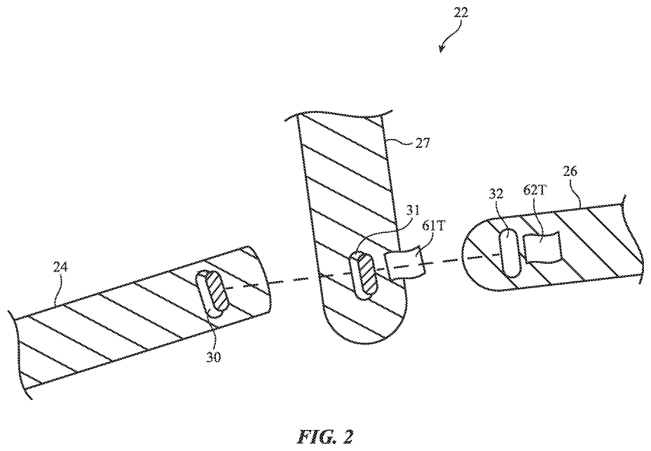

FIG. 2 is an illustrative diagram of an end portion of an illustrative headband 26, an end portion of an illustrative headband 27, and a corresponding end portion of an illustrative member 24. Headband 26, headband 27, and housing structures such as members 24 may sometimes be collectively referred to as a forming a head-mounted device headband system (headband system) 22. As shown in the example of FIG. 2, member 24 may have a protruding post such as post 30 (e.g., a post that protrudes out of member 24 towards a user's head while device 10 is being worn by the user). Headband 26 may have a corresponding opening 32 that is configured to receive post 30.

Post 30 may protrude inwardly (or, in some embodiments, outwardly) from member 24. Post 30 may be formed from metal, rigid polymer, other materials, and/or combinations of these materials. Member 24 may have a rigid portion to which post 30 is attached. This rigid portion may be formed from rigid polymer, metal, fabric, carbon-fiber composite materials, and/or other materials.

In the illustrative embodiment of FIG. 2, to attach headband 27 to post 30, headband 27 may include post 31. Post 31 may be formed from metal, rigid polymer, other materials, and/or combinations of these materials. In the present example, post 31 and post 30 have elongated shapes when viewed end-on (e.g., rectangular shapes with rounded corners). These elongated shapes may help resist rotational motion between longitudinal axis 34 of headband 26 and longitudinal axis 36 of member 24. This helps prevent headband 26 from slipping up or down along the rear surface of a user's head during use. In general, post 30 and/or mating opening 32 may have any suitable shapes (e.g., the shape of post 30 and/or opening 32 may be circular, oval, rectangular, triangular, may be a shape with curved edges and/or straight edges, may be a shape with drafted edges to help with alignment and/or insertion, etc.). The use of rectangular shapes with rounded corners and/or other shapes that are elongated is illustrative.

Post 31 may be slightly larger than post 30 to fit on top of post 30. If desired, post 31 may snugly fit onto post 30 to attach headband 27 to member 24. Additionally or alternatively, post 31 may include a latch, such as a structure biased with a spring or other suitable latch that engages an opening in the side of post 30, a magnet, or another suitable attachment to attach headband 27 to member 24. If a latch is used to attach headband 27 to post 30, tab 61T may be attached to the latch, and may be pulled to disengage the latch so that headband 27 may be released from member 24.

Opening 32 in headband 26 may be a through-hole opening with a shape that matches the outline of post 31. Through-hole opening 32 may be formed by cutting or otherwise forming an opening in headband 26. The periphery of opening 32 may be strengthened using a mating pair of ring members, which may sometimes be referred to as a cap and socket and may capture portions of headband 26.

In the present example, post 31 and opening 32 have elongated shapes when viewed end-on (e.g., rectangular shapes with rounded corners). Headband 26 may have a latch such as a structure biased with a spring or other suitable latch, in opening 32 that engages an opening in the side of post 31 to attach headband 26 to headband 27. Tab 62T may be attached to the latch, and may be pulled to disengage the latch so that headband 26 may be released from headband 27.

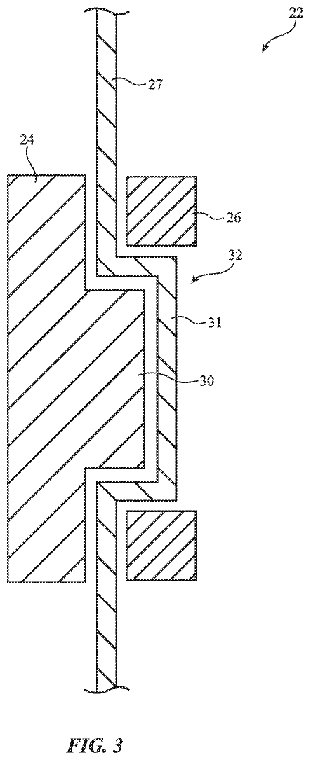

By including post 31 on headband 27 to overlap and attach to post 30, both headband 27 and headband 26 may be attached to member 24. An illustrative cross-sectional side view of member 24, headband 26, and headband 27 attached together is shown in FIG. 3.

As shown in FIG. 3, post 30 on member 24 may extend into post 31 of headband 27. For example, post 31 may be a small amount larger than post 30 (e.g., less than 1 mm larger, less than 2 mm larger, or other suitable size difference) to allow post 31 to press onto post 30 and remain attached to post 30. Post 31 may then be inserted into opening 32 of headband 26, thereby attaching headband 26 to headband 27 and member 24.

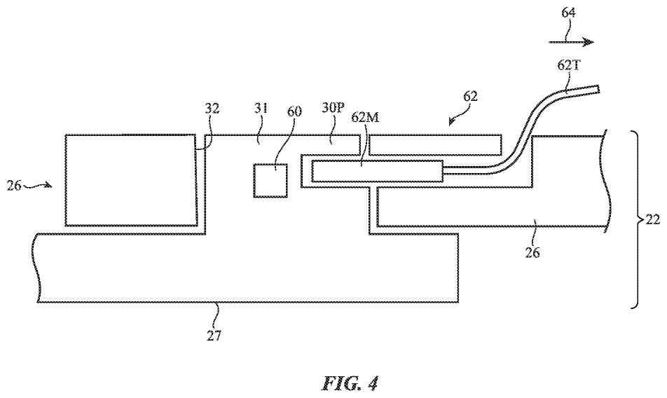

In some embodiments, post 31 may be attached to post 30 with a latch, and/or headband 26 may be attached to post 31 with a latch. A cross-sectional side view of an illustrative latch that may be used to attach posts 30 and 31, and/or headband 26 and post 31 is shown in FIG. 4.

As shown in FIG. 4 system 22 may include a latching mechanism such as latch 62. Latch 62, which may sometimes be referred to as a latch mechanism or latch structures, may be opened and closed using magnets, springs, sliding members, toggling members, rotating members such as knobs, buttons, and/or other latch structures that may be manipulated by a user (e.g., a user's fingers). In the example of FIG. 4, the latch of headband 26 has a movable latch member that engages post 31 when post 31 is within opening 32 and has an associated release mechanism such as release tab 62T. Tab 62T, which may be formed from a flexible strip of material (e.g., fabric, polymer, and/or other material) may be pulled in direction 64 by a user (e.g., when a user grasps tab 62T between the user's fingers), thereby moving the movable latch member out of engagement with post 31. This releases post 31 and allows post 31 to be removed from opening 32. Magnets, spring structures, and/or other biasing structures may be used in closing the latch. In some embodiments, headband 27 and headband 26 may have magnets that facilitate attachment of headband 27 and headband 26. As shown in FIG. 4, for example, post 31 may have one or more magnets such as magnet 60. Magnet 60 may be used to attract and/or repel corresponding magnets in headband 26, which can assist in attaching headband 26 to headband 27 and/or can assist in closing latch 62.

Although FIG. 4 shows latch 62 attaching headband 26 to headband 27, latch 62 may additionally or alternatively be used to attach headband 27 to member 24. In particular, latch 62 may be formed in post 31 of headband 27, and may be moved in and out of a recess within post 30 of member 24 using tab 61T. In this way, headband 27 may be removably coupled to member 24 with a latch, such as latch 62.

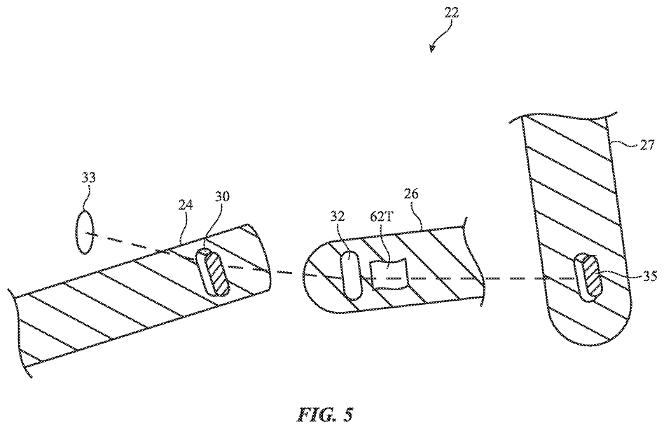

In addition to, or instead of, using a post on headband 27 to attach headband 27 to member 24, magnets may be used for this attachment. An illustrative embodiment in which headband 27 is attached to member 24 using magnets is shown in FIG. 5.

As shown in FIG. 5, headband 26 may attach to post 30 at opening 32. For example, headband 26 may attach to post 30 in the same manner as headband 26 attaches to post 31 in FIG. 3. In particular, a latch in opening 32 (e.g., latch 62 of FIG. 4) may move into an opening within post 30, removably attaching headband 26 to member 24.

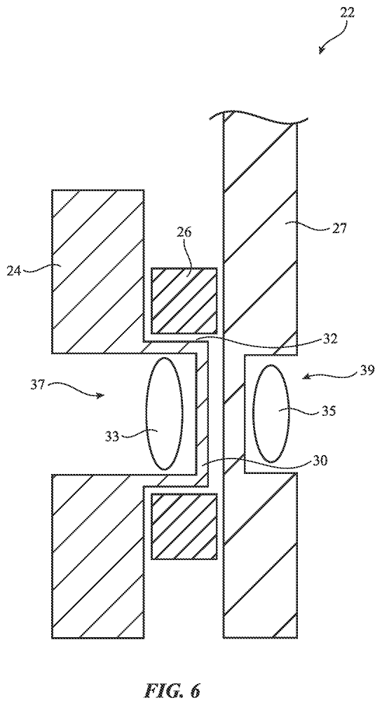

Headband 27 may be magnetically attached to post 30. In particular, magnet 33 may be inserted within post 30, and magnet 35 of headband 27 may be magnetically attached to magnet 33 of post 30. Because post 30 passes through opening 32 of headband 26, headband 27 may contact the upper surface of post 30, as magnets 33 and 35 attract post 30 and headband 27 together. An illustrative cross-sectional view of a magnetic attachment of headband 27 and member 24 is shown in FIG. 6.

As shown in FIG. 6, member 24 may have recess 37 formed in post 30. Magnet 33 may be coupled to post 30 within recess 37. Similarly, headband 27 may include recess 39, and magnet 35 may be coupled to headband 27 within recess 39. Magnets 33 and 35 may attach headband 27 to member 24.

Headband 26 may be between member 24 and headband 27 when headband 27 is magnetically attached to member 24. In particular, opening 32 of headband 26 may surround post 30. Headband 26 may be removably attached to member 24 with a latch in opening 32 (as shown in FIG. 5), and/or headband 26 may remain attached to member 24 due to headband 27 being magnetically attached to member 24.

The presence of recesses 37 and 39 to accommodate magnets 33 and 35 are merely illustrative. In general, one or more magnets may be attached to each of member 24 and headband 27 in any suitable manner.

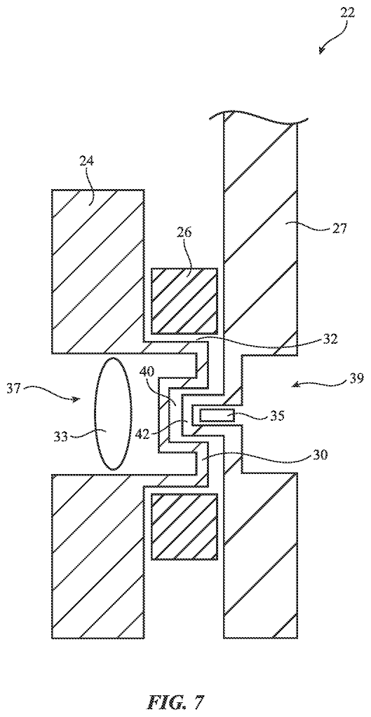

Instead of, or in addition to, having recesses to accommodate magnets in member 24 and/or headband 27, recesses and protrusions may help attach and align headband 27 to member 24. An illustrative embodiment in which a recess and a protrusion are used for aligning and attaching member 24 and headband 27 is shown in FIG. 7.

As shown in FIG. 7, in addition to having magnets 35 and 33 coupling headband 27 to member 24, member 24 may have recess 40 in post 30, and headband 27 may have protrusion 42. Protrusion 42 may be inserted within recess 40 when headband 27 and member 24 are attached, which may improve the alignment and/or the attachment of headband 27 and member 24.

As in the embodiment of FIG. 6, headband 26 may be between member 24 and headband 27 when headband 27 is magnetically attached to member 24. In particular, opening 32 of headband 26 may surround post 30. Headband 26 may be removably attached to member 24 with a latch in opening 32 (as shown in FIG. 5), and/or headband 26 may remain attached to member 24 due to headband 27 being magnetically attached to member 24.

Although member 24 is shown as having recess 40, and headband 27 is shown as having protrusion 42, this is merely illustrative. Headband 27 may have a recess in which a protrusion of member 24 is inserted, if desired.

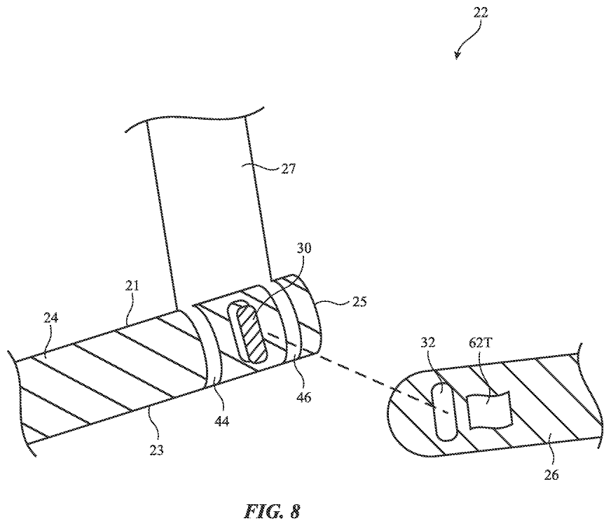

In other embodiments, headband 27 may be attached to member 24 directly, rather than at post 30, such as by wrapping around member 24 or clipping onto member 24. An illustrative embodiment in which headband 27 is attached to member 24 directly is shown in FIG. 8.

As shown in FIG. 8, headband 27 may be attached to member 24 with portions 44 and 46 that wrap around member 24. In particular, portions 44 and 46 may extend from the rest of headband 27, and may be on either side of post 30 of member 24. In some embodiments, headband 27 may be slid onto member 24 at end 25, and portions 44 and 46 may attach headband 27 to member 24.

Headband 26 may attach to post 30 directly, as opening 32 of headband 26 may surround post 30. Headband 26 may be removably attached to member 24 with a latch in opening 32 (as shown in FIG. 5) or another mechanism.

Although FIG. 8 shows portions 44 and 46 wrapping entirely around member 24, this is merely illustrative. If desired, headband 27 may have a single or multiple portions that clip onto (e.g., extend partially around) edges 21 and 23 of member 24. In this arrangement, headband 27 may be detached from member 24 (e.g., by unclipping the clip-on portions) without removing headband 26 from post 31. Alternatively or additionally, portion 46 may extend around and cover end 25 of member 24.

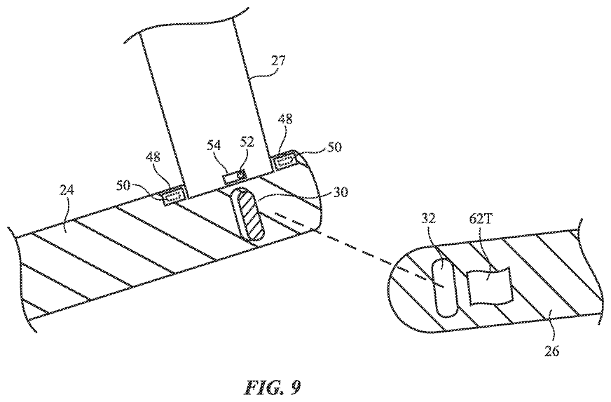

Instead of having portions of headband 27 that surround member 24 or clip onto member 24, headband 27 may include lugs that fit into openings in member 24 (e.g., headband 27 and member 24 may have a lug and socket system to attach headband 27 to member 24). An illustrative example of headband 27 attached to member 24 with a lug and socket system is shown in FIG. 9.

As shown in FIG. 9, headband 27 may have lugs 48 that are received within sockets 50 of member 24. Lugs 48 may be coupled by one or more springs or otherwise biased outward (e.g., into sockets 50). To release headband 27 from member 24, sliding member 52 may be slid within opening 54 of headband 27 to retract one of lugs 48. Headband 27 may then be removed from member 24. Headband 27 may be reattached to member 24 by inserting lugs 48 into sockets 50, which may include retracting one of the lugs by sliding member 52 within opening 54. In this way, headband 27 may be attached to member 24 using a lug and socket system.

Headband 26 may attach to post 30 directly, as opening 32 of headband 26 may surround post 30. Headband 26 may be removably attached to member 24 with a latch in opening 32 (as shown in FIG. 5) or another mechanism.

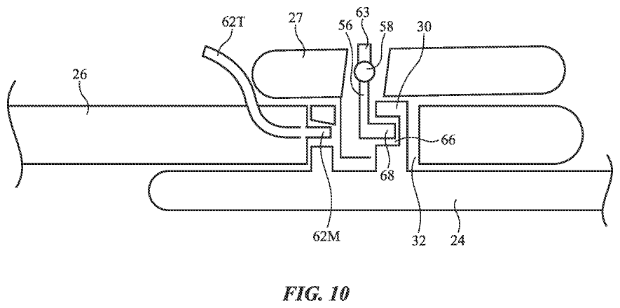

In some embodiments, post 30 of member 24 may be modified to accommodate both headband 26 and headband 27. For example, headband 27 may have an additional latch that connects headband 27 to member 24. An illustrative example of attaching headband 27 to member 24 with an additional latch is shown in FIG. 10.

As shown in FIG. 10, headband 27 may include latch 56, and member 24 may have post 30 with recess 66. Latch 56 may be formed from metal, rigid polymer, or other material. Latch 56 may include protruding portion 68 that attaches to post 31 within recess 66. For example, latch 56 may be biased toward recess 66 by a spring, magnet, or other component. If it is desired to remove headband 27 from member 24, a user may push on portion 63 of latch 56 so that latch 56 rotates about hinge 58. Protruding portion 68 may slide out of recess 66, and headband 27 may be removed from member 24. To reattach headband 27, the user may use portion 63 to move protruding portion, which may move into position when released by the user. In some embodiments, post 30 and/or protruding portion 68 may be beveled so that user may insert headband 27 into post 30 without engaging portion 63 of latch 56.

Headband 26 may attach to post 30 directly, as opening 32 of headband 26 may surround post 30. Headband 26 may be removably attached to member 24 with a slidable latch member 62M that may be moved with tab 62T. As shown in FIG. 10, headband 26 may be attached to member 24 between member 24 and headband 27.

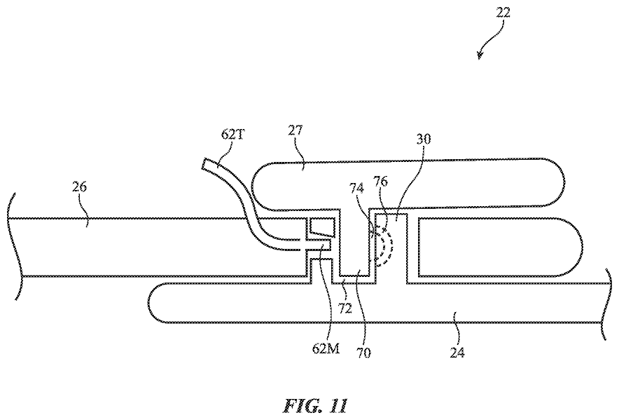

Instead of using latch 56 to attach headband 27 to member 24, an internal structure may be used. An illustrative example in which headband 27 is attached to member 24 using an internal structure is shown in FIG. 11.

As shown in FIG. 11, headband 27 may have protruding portion 70 that is inserted into opening 72 of post 30. Protruding portion 70 be formed from metal, rigid plastic, or other material. In some embodiments, protruding portion 70 may be slightly smaller (e.g., less than 1 mm smaller, less than 2 mm smaller, or other suitable difference) than opening 72. By inserting protruding portion 70 into opening 72, headband 27 may remain attached to member 24.

To remove headband 27 from, or attach headband 27 to, member 24, a user would merely have to apply enough force to overcome the friction between protruding portion 70 and opening 72.

If desired, additional material, such as material 74, may be added to protruding portion 70 to further secure headband 27 to member 24. Material 74 may be, for example, a polymer material, a gasket, or another suitable material. Post 30 may optionally have recess 76 that matches the shape of material 74 to hold protruding portion 70 in place within opening 72.

To remove headband 27 from, or attach headband 27 to, member 24, a user would merely have to apply enough force to overcome the friction between material 74 and the sides of opening 72 (or the recess 76 once inserted).

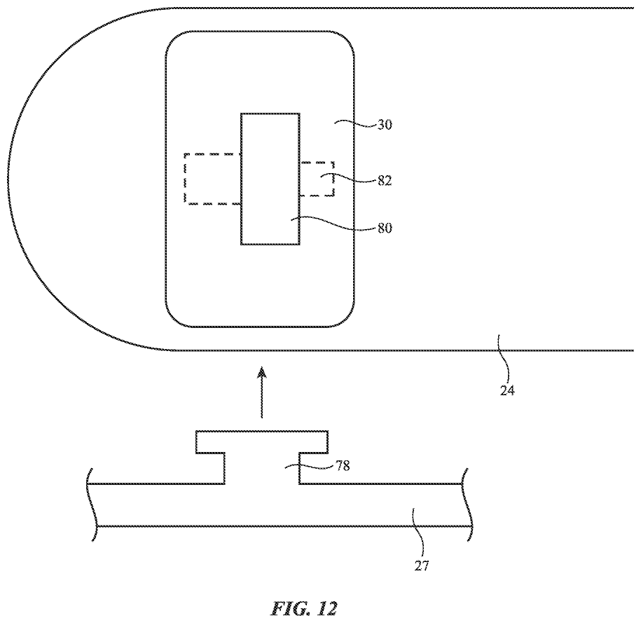

Another attachment mechanism for coupling headband 27 to member 24 is a twist-to-lock system. An illustrative example of a twist-to-lock system is shown in FIG. 12

As shown in FIG. 12, headband 27 may have protrusion 78. Member 24 may have post 30 with opening 80. Protrusion 78 may fit through opening 80 perpendicularly, and may be twisted into proper position 82 once protrusion 78 passes through opening 80. Post 30 may have an at least partially hollow interior to allow protrusion 78 to swivel within post 30 into position 82. Once protrusion 78 is in position 82 within post 30, it may be locked into place. A user may detach headband 27 from member 24 by twisting headband 27 so that protrusion 78 is aligned with opening 80. In this way, a twist-to-lock system may attach headband 27 to member 24.

Although not shown in FIG. 12, headband 27 and post 30 may include magnets to further attach headband 27 to member 24. These magnets may be similar to those shown in FIGS. 5-7.

Moreover, although not shown in FIG. 12, headband 26 may be between member 24 and headband 27 prior to attaching headband 27 to member 24 with the twist-to-lock system. In particular, opening 32 of headband 26 may surround post 30. Headband 26 may be attached with a latch, such as the latch of FIG. 5, and/or may be held in place by headband 27 once it is attached to post 30 with the twist-to-lock system.

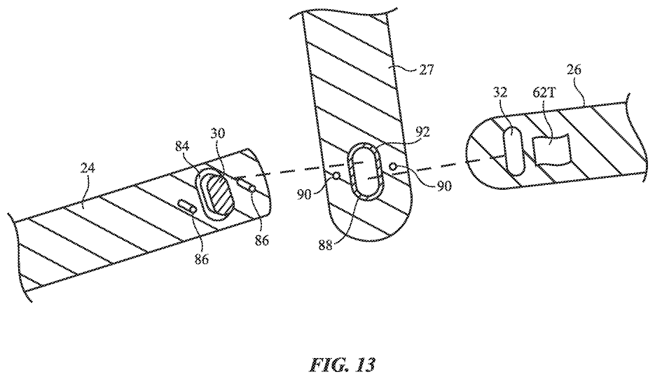

In some embodiments, headband 27 may be attached to member 24 and held in place by headband 26 attaching to member 24 with a latch. An illustrative example of such an embodiment is shown in FIG. 13.

As shown in FIG. 13, member 24 may have post 30 with shoulder 84. Member 24 may also have pins 86, although pins 86 may be omitted if desired. Headband 27 may have opening 88 that is slightly larger (e.g., less than 1 mm larger, less than 2 mm larger, or other suitable difference) than shoulder 84 of post 30. Headband 27 may be attached to member 24 by passing post 30 through opening 88, so that headband 27 surrounds shoulder 84.

To prevent headband 27 from detaching from member 24, headband 26 may be attached to post 30. In particular, opening 32 of headband 26 may surround post 30, and headband 26 may be removably attached to member 24 with a latch in opening 32 (as shown in FIG. 5) or another mechanism. When the latch is engaged and headband 26 is attached to member 24, headband 26 will be unable to detach from member 24.

Optional pins 86 may pass through optional holes 90 in headband 27. Pins 86 may prevent headband 27 from moving/rotating with respect to member 24. In this way, pins 86 may maintain headband 27 in a desired position on the user's head when worn.

Elastomer 92 may surround opening 88. Elastomer 92 may be formed from any desired elastomeric material, and may help prevent headband 27 from moving with respect to shoulder 84 or detaching from post 30. However, elastomer 92 may be omitted, if desired.

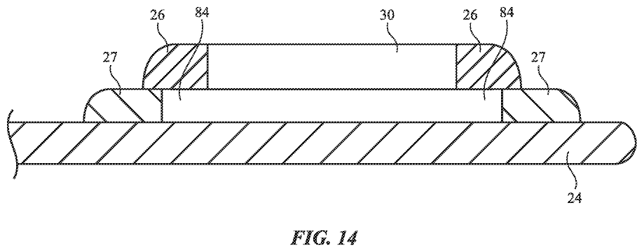

Regardless of whether elastomer 92 or pins 86 are included in the embodiment of FIG. 13, a cross-sectional side view is shown in FIG. 14. As shown in FIG. 14, headband 27 may surround shoulder portions 84 of post 30. Headband 26 may then rest on top of shoulders 84 of post 30. In this way, headband 27 may be held in place against member 24 by headband 26.

Although not shown in FIGS. 13 and 14, because headband 27 will be directly on member 24, material may be included on member 24 to keep headband 27 from moving (e.g., swiveling) when the head-mounted device is worn. For example, a gasket, such as a compressible gasket, elastomeric material, or other material may be formed on the surface of member 24 that is contacted by headband 27 when headband 27 is attached to member 24.

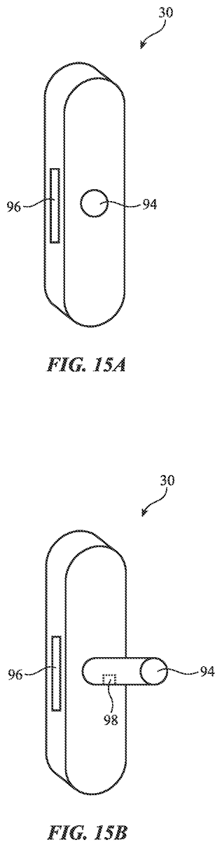

In some embodiments, headband 27 may be attached to member 24 with extendable magnets. Illustrative embodiments in which headband 27 is attached to member 24 with extendable magnets are shown in FIGS. 15A-17B.

As shown in FIG. 15A, post 30 may have magnet 94 in a stowed (e.g., non-extended) position. Post 30 may also include opening 96, which may accommodate a latch mechanism to attach headband 26 (e.g., the latch mechanism of FIG. 5). As shown in FIG. 15B, magnet 94 may extend into an extended position. Magnet 94 may include optional recess 98, which may be used to attach headband 27 to member 24.

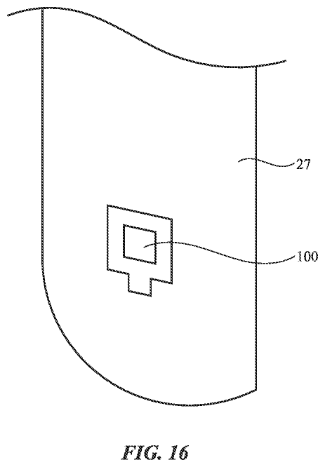

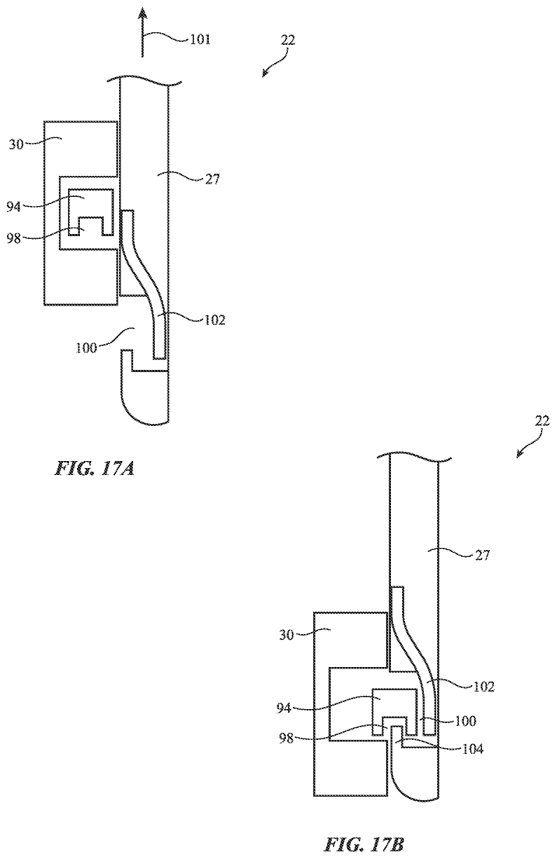

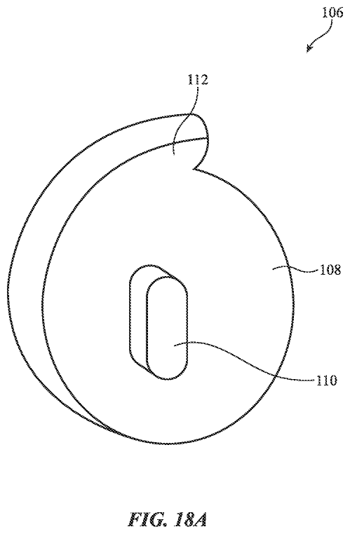

As shown in FIG. 16, headband 27 may have opening 100. Opening 100 may receive magnet 94 when it is in the expanded position. Illustrative examples of magnet 94 expanding and attaching headband 27 is shown in FIGS. 17A and 17B.

As shown in FIG. 17A, headband 27 may be brought into contact with post 30 (e.g., with member 24). Headband 27 may have stationary magnet 102 within opening 100. As headband 27 is moved in direction 101, magnet 102 may attract magnet 94 in post 30.

Eventually, as shown in FIG. 17B, magnet 94 may be moved into opening 100 of headband 27 due to the attractive magnetic force of magnet 102. Recess 98 of magnet 94 may be coupled to portion 104 of opening 100, thereby attaching headband 27 to post 30 with magnet 94. In this way, an extendable magnet may attach headband 27 to post 30 (and to member 24).

Although the embodiments of FIGS. 2-17B have described attaching headband 27 to member 24 in a variety of ways, this is merely illustrative. In general, headband 26 or any other headband may be attached to member 24 using any of the attachments of FIGS. 2-17B. Alternatively or additionally, although sometimes described herein in the context of examples where posts 30 are formed on members 24 and openings 32 are formed in headband 26, posts 30 may, if desired, be formed as part of headband 26 and openings 32 may be formed in members 24.

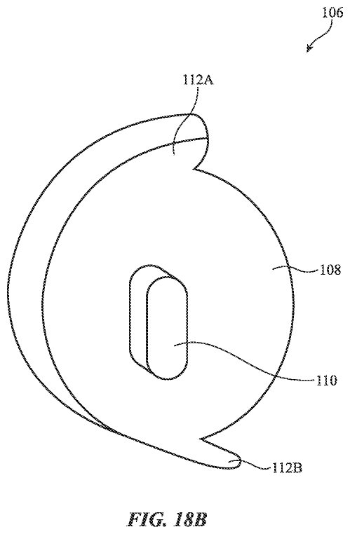

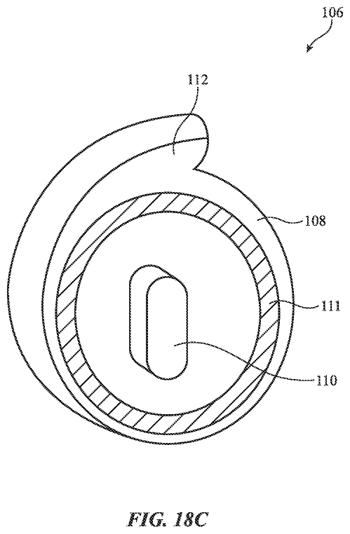

Regardless of the attachment used to attach headband 27 to member 24, it may be desirable to incorporate a hair guard into a head band system. Illustrative examples of hair guards that may be incorporated into a head band system is shown in FIGS. 18A-18C.

As shown in FIG. 18A, hair guard 106 may include post 110 on body 108. Body 108 may be formed from metal, polymer, a compliant material (e.g., rubber, foam, or a hybrid/mixed material), or other suitable material. Post 110 may be formed similarly to post 31 (FIG. 3). In other words, post 110 may fit over a post, such as post 30 of FIG. 2, on a headband to attach hair guard 106 to the headband. However, the use of post 110 to attach hair guard 106 to a headband is merely illustrative. Hair guard 106 may be attached to a headband using an adhesive, may be integrated to a headband or head-mounted device housing (e.g., a head-mounted support structure), may be magnetically attached to a headband, or may be held in place due to the pinching of two headbands on either side of hair guard 106.

Hair guard 106 may have contoured portion 112. Contoured portion 112 may be, for example, a contoured edge that redirects hair of a user away from gaps between headbands in a headband system. Contoured portion 112 may have any suitable curvature, such as a curvature that matches the curvature of an adjacent headband, 3D curvature, and/or any other suitable curvature. In some embodiments, such as when hair guard 106 is formed from a compliant material, hair guard 106 may have an adjustable curvature (e.g., one or more adjustable contoured portions). In this way, hair guard 106 may be adjusted to have a curvature that matches the curvature of an adjacent headband.

Hair guard 106 may have any suitable number of contoured portions. In the illustrative example of FIG. 18B, hair guard 106 may have two contoured portions 112A and 112B on opposite sides of hair guard 106. Having two or more contoured portions 112 may allow hair guard 106 to better prevent hair from being caught between headbands in a headband system.

Hair guard 106 may also include gap filler material to fill the gaps between hair guard 106 and adjacent headbands. As shown in the illustrative example of FIG. 18C, hair guard 106 may include gap filler 111 on the surface of body 108. Gap filler 111 may be formed from foam, silicone, fabric, or other suitable material, and may be adhesively attached or otherwise attached to hair guard 106. In some embodiments, gap filler 111 may be a compressible gasket. Gap filler 111 may have a thickness of at least 0.5 mm, less than 1 mm, between 0.2 mm and 0.8 mm, or other suitable thickness. Gap filler 111 may have a diameter of at least 20 mm, less than 30 mm, between 18 mm and 25 mm, or other suitable diameter.

In the example of FIG. 18C, gap filler 111 forms a ring that extends over a portion of the surface of hair guard 106. However, this is merely illustrative. In general, gap filler 111 may cover any suitable portion of hair guard 106. When attached to a headband, such as using post 110, gap filler 111 may fill the gap between hair guard 106 and the headband, further preventing hair from entering the gap.

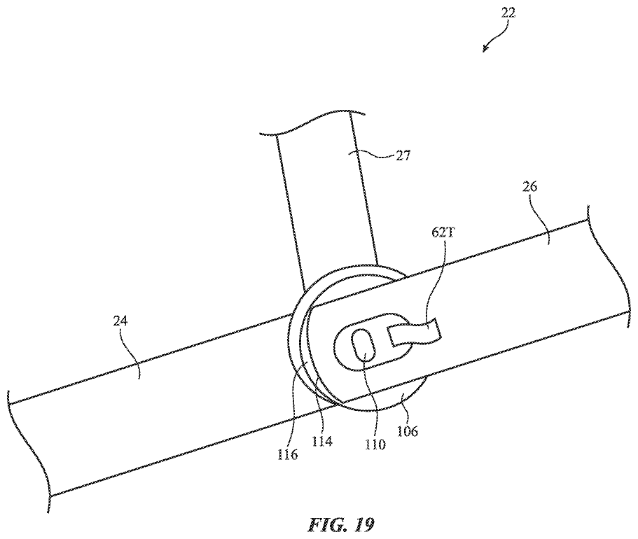

A perspective view of a headband system that includes a hair guard is shown in FIG. 19. As shown in FIG. 19, headband system 22 may include hair guard 106 between headband 26 and headband 27 (or member 24). Because hair guard 106 fills the gap between headband 26 and headband 27 (or member 24), hair of a user of headband system 22 may be less likely to enter the space between the headbands.

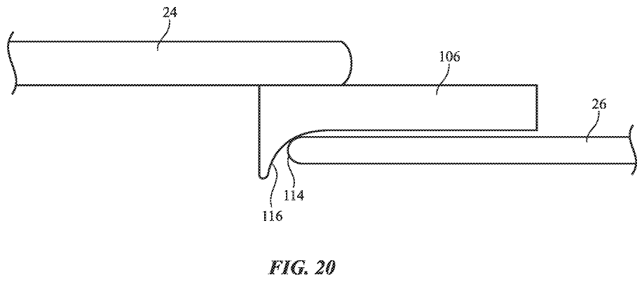

To increase the prevention of hair entering the gap between the headbands, hair guard 106 may have curvature 116 that matches curvature 114 of headband 26 at the point at which hair guard 106 contacts headband 26. A side view of illustrative curvature 116 of hair guard 106 matching curvature 114 of headband 26 is shown in FIG. 20. However, the specific curvatures 114 and 116 in FIG. 20 are merely illustrative. In general, the curvatures of hair guard 106 and headband 26 may match to reduce the gap between hair guard 106 and headband 26, and hair may be prevented from entering the gap.

Although FIGS. 19 and 20 show the curvatures of hair guard 106 and headband 26 matching in a single direction, this is merely illustrative. In general, the curvature of hair guard 106 may match the curvature of headband 26 in any suitable direction(s) to prevent hair from entering a gap between hair guard 106 and headband 26. Alternatively or additionally, the curvature of hair guard 106 may match the curvature of member 24 and/or headband 27 to prevent hair from entering gaps between those portions of the headband system.

Moreover, although FIGS. 19 and 20 show the incorporation of hair guard 106 in a headband system with three headbands, this is merely illustrative. In general, hair guard 106 may be incorporated in any headband system with two or more headbands.

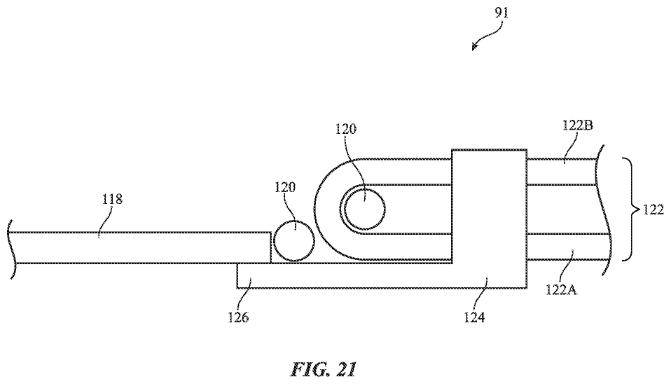

In some embodiments, a keeper loop may be incorporated between portions of a headband to allow for the headband to be adjusted, while maintaining the positions of the portions of the headband relative to one another. An illustrative example of a headband with a keeper loop is shown in FIG. 21.

As shown in FIG. 21, headband 91 (which may correspond with headband 27 or headband 26 of FIG. 1) may have headband portions 118 and 122. Adjuster loop 120 may be coupled to headband portion 118. For example, headband portion 118 may be adhesively coupled to adjuster loop 120, may be tied around adjuster loop 120, may be received within a cavity of adjuster loop 120, or otherwise may be attached to adjuster loop 120.

Headband portion 122 may have first portion 122A and second portion 122B separated by a portion of adjuster loop 120. In other words, second portion 122B may double back on first portion 122A after passing through adjuster loop 120. By adjusting the amount of headband portion 122 that passes through adjuster loop 120, the size of headband 91 may be adjusted.

Keeper loop 124 may be included in headband 91 to maintain the position of headband portions 118, 122A, and 122B. Keeper loop 124 may be formed from reinforced fabric. For example, keeper loop 124 may be reinforced with one or more polyethylene terephthalate (PET) layers or other polymer layers, one or more fiberglass layers, one or more adhesive layers, and/or one or more fabric layers. These layers may then be covered by a fabric, such as a webbing.

Keeper loop 124 may have portion 126 attached to headband portion 118, such as using an adhesive. Alternatively, portion 126 may be woven or otherwise attached to headband portion 118. By attaching portion 126 of keeper loop 124 to headband portion 118, keeper loop 124 may maintain its position relative to headband portion 118, preventing keeper loop 124 from sliding down headband portion 122.

Although FIG. 21 shows keeper loop 124 attached headband portion 122 directly, keeper loop 124 may be attached to (e.g., tucked into an opening of) adjuster loop 120, if desired.

First and second portions 122A and 122B of headband portion 122 may pass through keeper loop 124. Keeper loop 124 may keep headband portion 122 flat and minimize the bend radius between portions 122A and 122B, allowing headband 91 to have a low profile. In particular, the position of keeper loop 124 relative to adjuster loop 120 may minimize this bend radius.

As shown in FIG. 21, adjuster loop 120 may be oriented at an angle relative to the plane of headband portion 118, such as with an angle of at least 20°, at least 30°, or at least 40°, as examples. By orienting adjuster loop 120 in this way, portion 122A of headband portion 122 may be aligned with headband portion 118 (e.g., the plane of portion 122A may be coplanar with the plane of headband portion 118). Aligning portion 122A with headband portion 118 may allow for headband 91 to be more comfortable when worn, allow for easier adjustments of headband 91, and/or prevent adjuster loop 120 from contacting the user's head.

Keeper loop 124 may maintain the curvature of headband 91 when headband 91 is not being worn. In particular, because keeper loop 124 is attached to headband portion 118 and to headband portion 122, the shape of headband 91 may be maintained when it is not on a user's head. Similarly, because keeper loop 124 contacts both sides of the headband, keeper loop 124 may prevent the headband from becoming disconnected if it is not properly fastened.

When headband 91 is worn, keeper loop 124 may separate adjuster loop 120 from the user's head. Additionally or alternatively, the friction between keeper loop 124 and headband portion 122 may prevent headband portion 122 from moving relative to adjuster loop 120.

Although FIG. 21 shows portions 122A and 122B passing through a common opening of keeper loop 124, this is merely illustrative. Keeper loop 124 may have two openings, with portions 122A and 122B each passing through one of the openings, if desired. For example, fabric, which may be reinforced with PET, fiberglass, and/or other material, may separate the two openings.

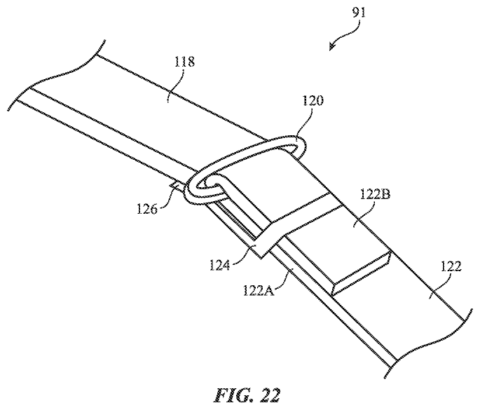

An illustrative perspective view of headband 91 with keeper loop 124 is shown in FIG. 22. As shown in FIG. 22, the use of keeper loop 124 may maintain a small bend radius between portions 122A and 122B of headband portion 122 as it passes through adjuster loop 120.

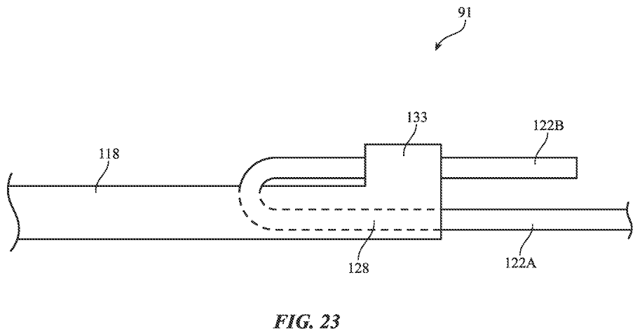

In some embodiments, adjuster loop 120 may be omitted. An illustrative example of a headband without an adjuster loop is shown in FIG. 23.

As shown in FIG. 23, headband portion 118 of headband 91 may include cavity 128 and integral keeper loop 133. Keeper loop 133 may be formed from the same materials as keeper loop 124 (FIG. 21). For example, the fabric layer(s) of keeper loop 133 may be woven or otherwise attached to the fabric of headband portion 118.

Portion 122A of headband portion 122 may pass through cavity 128 before doubling back as headband portion 122B through keeper loop 133. In this way, an adjuster loop may be omitted from headband 91, and headband portion 122 may still have a low profile due to keeper loop 133.

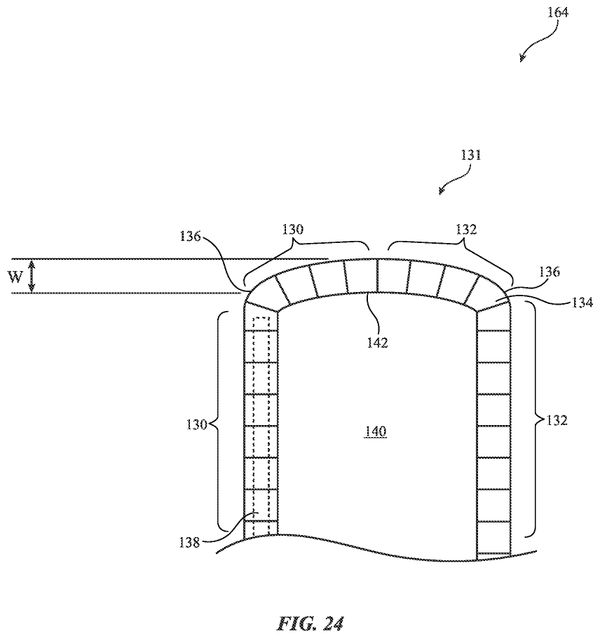

In some embodiments, it may be desirable to create a curved edge that appears seamless at the end of a headband. An illustrative headband portion with a curved edge with a seam that is invisible to the naked eye is shown in FIG. 24.

As shown in FIG. 24, headband portion 164, which may correspond with headband 27 or headband 26 of FIG. 1, as examples, may include strap 131. Strap 131 may be formed from inner woven portion 140 and webbing 134. In particular, webbing 134 may be sewn, woven, or otherwise coupled to woven portion 140. Webbing 134 may have a width W from edge 142 of woven portion 140 of at least 2 mm, of 2.65 mm, of 5 mm, of between 2.5 mm and 5 mm, or of less than 7 mm, as examples. Woven portion 140 may have a solid loop weave or a ribbed loop weave, as examples.

Although portion 140 has been described as being woven, this is merely illustrative. In general, portion 140 may be knitted, woven, braided, and/or formed using other strand intertwining techniques.

Webbing 134 may have portion 130 that wraps from one side of inner woven portion 140 (e.g., the left side of inner woven portion 140 in FIG. 24), across part of edge 142. Additionally, webbing 134 may have portion 132 that wraps from an opposing side of inner woven portion 140 (e.g., the right side of inner woven portion 140 in FIG. 24) across part of edge 142. Portions 130 and 132 may meet along edge 142, such as in the center of edge 142.

A stiffener may be inserted into webbing 134, if desired. In the illustrative example of FIG. 17, stiffener 138 may be inserted into webbing 134, such as one side of webbing 134. In particular, webbing 134 may have multiple layers, and stiffener 138 may be inserted between the multiple layers. Alternatively, webbing 134 may be formed as a single piece using a flat knitting technique and includes a built-in channel (sometimes referred to as a pocket or cavity), and stiffener 138 may be inserted into the built-in channel. In general, however, stiffener 138 may be inserted into webbing 134 in any desired manner.

Stiffener 138 may be formed from a cord, such as a braided cord, or a flexible strip of polymer (e.g., an elastomer such as thermoplastic polyurethane). Stiffener 138 may be sufficiently flexible to permit the headband to bend and twist, but may not stretch substantially along its length and may therefore sometimes be referred to as a non-stretchable stiffener, non-stretchable member, non-stretchable stiffening structure, etc. Stiffener 138 may be significantly less stretchy and soft than the fabric of strap 131 and may serve to increase the stiffness and decrease (or eliminate) stretchiness at desired portions along strap 131. At the same time, the flexibility of stiffener 138 may allow strap 131 to bend around the curvature of a user's head. Stiffener 138 may be inserted into selected portions of strap 131 to selectively stiffen strap 131 at desired portions along its length, if desired. For example, stiffener 138 may be inserted into one or both sides of strap 131 and/or an edge of strap 131.

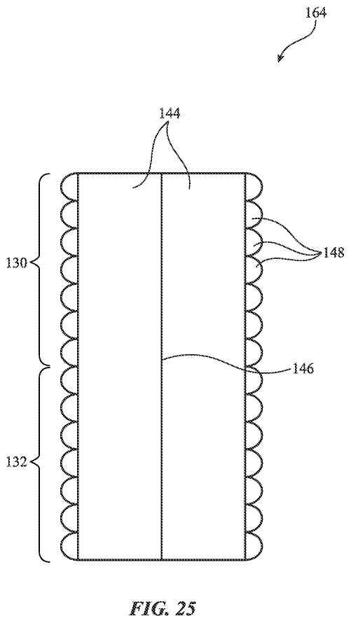

Headband portion 164 may have rounded corners 136 of webbing 134 and may not have visible seams (e.g., where portions 130 and 132 meet). An illustrative side view of headband portion 164 is shown in FIG. 25.

As shown in FIG. 25, headband portion 164 may include layers 144 and loops 148 (e.g., in webbing 134 of FIG. 24). Webbing from one side of headband portion 164 (e.g., portion 130) may be bonded to the webbing from the other side of headband portion 164 (e.g., portion 132) at point 146 (e.g., headband portion 164 may have single seam at point 146, such as along edge 142 of FIG. 24). As shown in FIG. 25, there may be no visible seam at point 146. In this way, a seam that is not visible to the naked eye may be formed in headband portion 164.

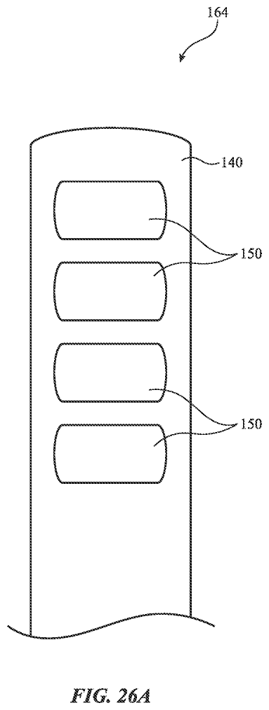

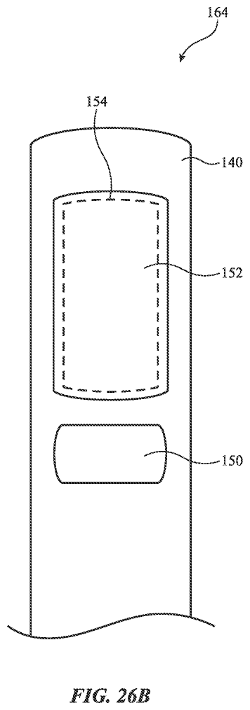

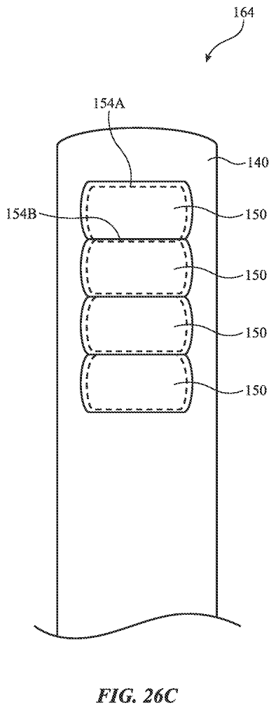

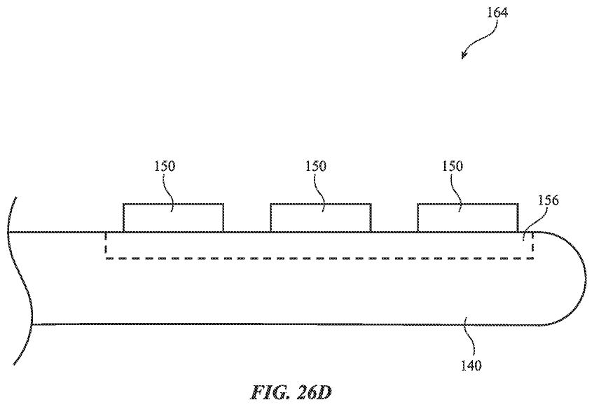

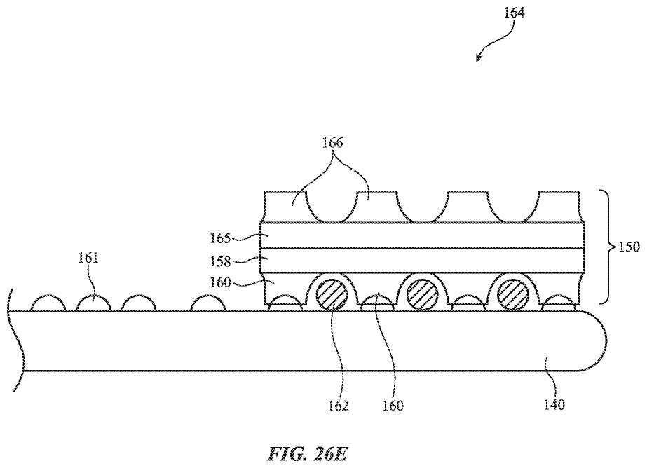

In some embodiments, hook and loop fasteners (or other suitable fasteners) may be incorporated into a headband to allow the headband to be adjusted and to maintain the position of the headband once it is adjusted. The hook and loop fasteners may be coupled to the headband using adhesive, sewing the fasteners to the headband, and/or partially embedding the fasteners within the headband. Illustrative examples are shown in FIGS. 26A-26E.

As shown in FIG. 26A, hook and loop fasteners 150 may be coupled to portion 140 of headband portion 164. For example, hook and loop fasteners may be adhesively attached to headband portion 164.

Alternatively, as shown in the illustrative example of FIG. 26B, a single, large hook and loop fastener 152 may replace one or more of hook and loop fasteners 150. Hook and loop fastener 152 may be stitched to, knitted to, adhesively attached to, and/or otherwise attached to headband portion 164. As indicated by stitch line 154, for example, hook and loop fastener 152 may be stitched to headband portion 164.

As another example, multiple hook and loop fasteners 150 may be used and may have adjoining edges. As shown in the illustrative example of FIG. 26C, hook and loop fasteners 150 may abut one another. As indicated by stitch line 154A, each individual hook and loop fastener 150 may be stitched to headband portion 164. At the adjoining edges of adjacent hook and loop fasteners 150, shared stitch line 154B may be used to fasten the adjacent hook and loop fasteners 150 together and to headband portion 164. However, the use of fastening hook and loop fasteners 150 to headband portion 164 by stitching is merely illustrative. In general, hook and loop fasteners 150 may be coupled to headband portion 164 in any suitable manner, such as by knitting, adhering, and/or otherwise attaching hook and loop fasteners 150 to headband portion 164.

In some embodiments, hook and loop fasteners 150 may be formed on a substrate that is at least partially embedded within a headband. As shown in the illustrative example of FIG. 26D, hook and loop fasteners 150 may be formed on substrate 156. Substrate 156 may be embedded within headband portion 164, such as within woven portion 140. For example, headband portion 164 may have two fabric layers that face outwardly, and substrate 156 may be formed between the two fabric layers. In addition to embedding substrate 156 in headband portion 164, substrate 156 may be stitched to, adhered to, or otherwise attached to headband portion 164. In this way, hook and loop fasteners 150 may be further attached to headband portion 164.

As another example, double-sided hook and loop fasteners may be attached to a headband. In the illustrative example of FIG. 26E, hook and loop fastener 150 may include lower fasteners 160 formed on carrier 158 and upper fasteners 166 formed on carrier 165. Carriers 158 and 165 may be coupled to one another, such as with an adhesive. Lower fasteners 160 may be coupled to loops 161 on a surface of headband portion 164 (e.g., a portion of woven portion 140). Lower fasteners 160 may also optionally be attached to headband portion 164 using adhesive 162, if desired. Upper fasteners 166 may be used to couple headband portion 164 to another headband portion or to itself (e.g., if headband portion 164 doubles back on itself) to maintain the position of headband portion 164 after it is adjusted.

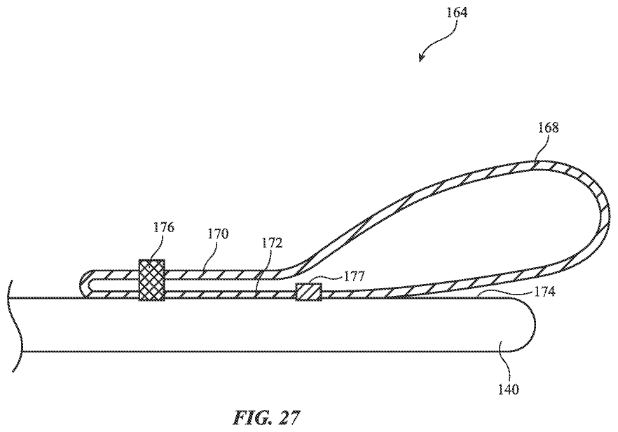

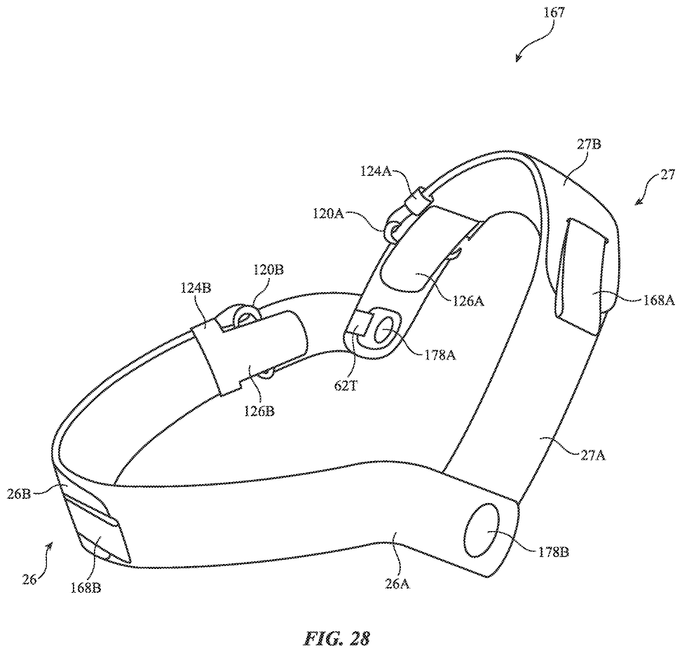

Regardless of the fasteners used to maintain the position of a headband, such as headband portion 164, it may be desirable to incorporate one or more pull tabs to adjust the headband portion. An illustrative example is shown in FIG. 27.

As shown in FIG. 27, pull tab 168 may be incorporated in headband portion 164, such as at the end of headband portion 164. In some embodiments, pull tab 168 may be formed on an opposite surface of headband portion 164 from hook and loop fasteners 150 (FIG. 26). Pull tab 168 may be formed from fabric, polymer, or other suitable material, such as a flexible material.

Pull tab 168 may have lower portion 172 in contact with upper surface 174 of headband portion 164. In particular, stitch 176 may be used to attach pull tab 168 to headband portion 164. Stitch 176 may extend through upper portion 170 and lower portion 172 of pull tab 168 and may attach pull tab 168 to headband portion 164. Lower portion 172 may be further attached to headband portion 164 using stitch 177. In this way, pull tab 168 may form a loop that is attached to one surface of headband portion 164 and that may be pulled by a user to release headband portion 164 (e.g., to adjust the fit of headband portion 164).

Although stitches 176 and 177 have been shown and described as stitches, this is merely illustrative. In general, pull tab 168 may be attached to headband portion 164 in any suitable manner, such as with an adhesive, using laser welding, or another suitable attachment.

An illustrative example of a headband system that includes adjuster loops, keeper loops, and pull tabs is shown in FIG. 28.

As shown in FIG. 28, headband system 167, which may correspond with system 22 (FIG. 2), may include upper headband 27 and lower headband 26. Upper headband 27 and lower headband 26 may both be coupled to a head-mounted support structure, such as in regions 178A and 178B, which may include openings 32, post 31, and/or other attachment structures.

Upper headband 27 may include keeper loop 124A with portion 126A. In particular, portion 27A of upper headband 27 may extend through keeper loop 124A, through adjuster loop 120A, and may double back through keeper loop 124A. Double-backed portion 27B of upper headband 27 may have pull tab 168A at the end of doubled-back portion 27B. On the opposite surface of double-backed portion 27B, one or more hook and loop fasteners (e.g., hook and loop fasteners 150 of FIG. 26) may be attached to secure double-backed portion 27B in place after it is adjusted.

Similarly, lower headband 26 may include keeper loop 124B with portion 126B. In particular, portion 26A of lower headband 26 may extend through keeper loop 124B, through adjuster loop 120B, and may double back through keeper loop 124B. Double-backed portion 26B of lower headband 26 may have pull tab 168B at the end of double-backed portion 26B. On the opposite surface of double-backed portion 26B, one or more hook and loop fasteners (e.g., hook and loop fasteners 150 of FIG. 26) may be attached to secure double-backed portion 26B in place after it is adjusted.

The arrangement of FIG. 28 is merely illustrative of a headband system that may include adjuster loops, keeper loops, and pull tabs. In general, one or more adjuster loops, keeper loops, and pull tabs may be incorporated into a headband system in any suitable manner.

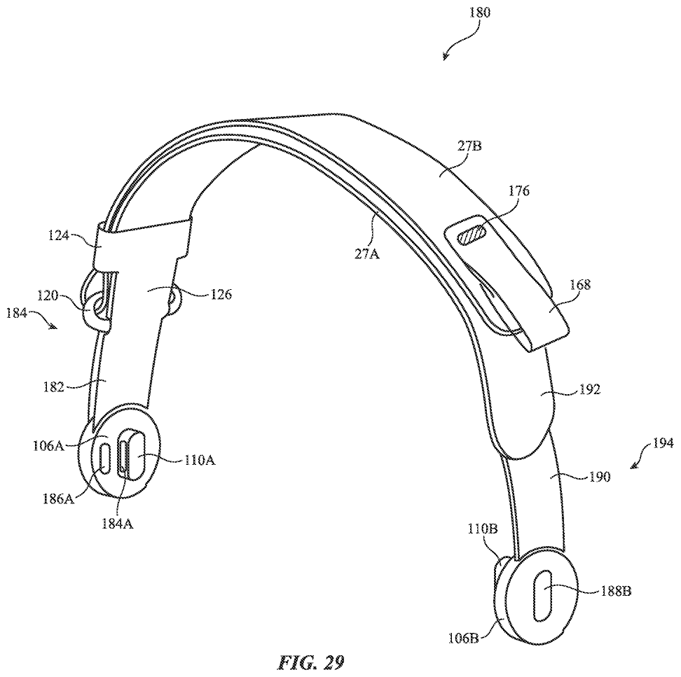

An illustrative example of an add-on overhead strap that includes adjuster loops, keeper loops, and pull tabs is shown in FIG. 29.

As shown in FIG. 29, headband 180, which may correspond with upper headband 27 of FIG. 1, may have temple portions 184 and 194. Temple portions 184 and 194 may be coupled to headband portions 27A and 27B.

Temple portion 184 may be formed at a first side of headband 180. Temple portion 184 may include hair guard 106A and temple webbing 182 attached to hair guard 106A. Temple webbing 182 may be formed integrally with keeper loop 124, including portion 126. Adjuster loop 120 may pass through the integral structure that includes temple webbing 182 and portion 126.

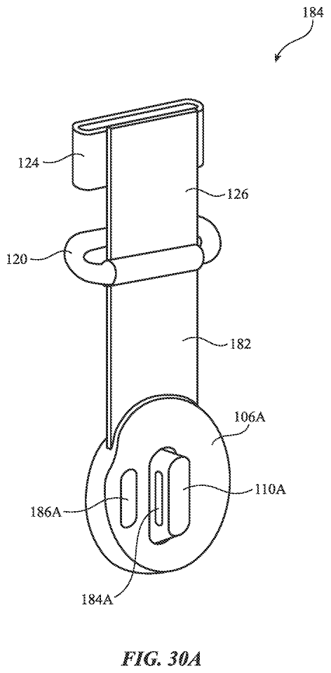

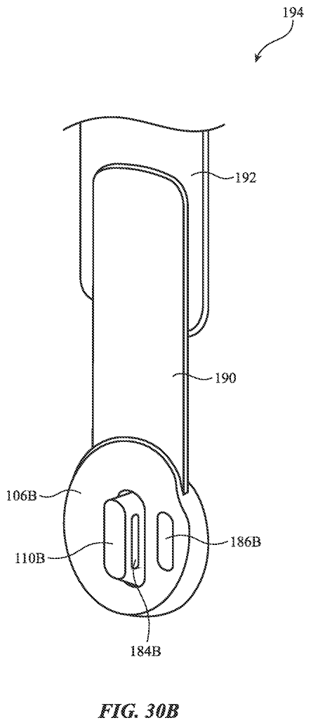

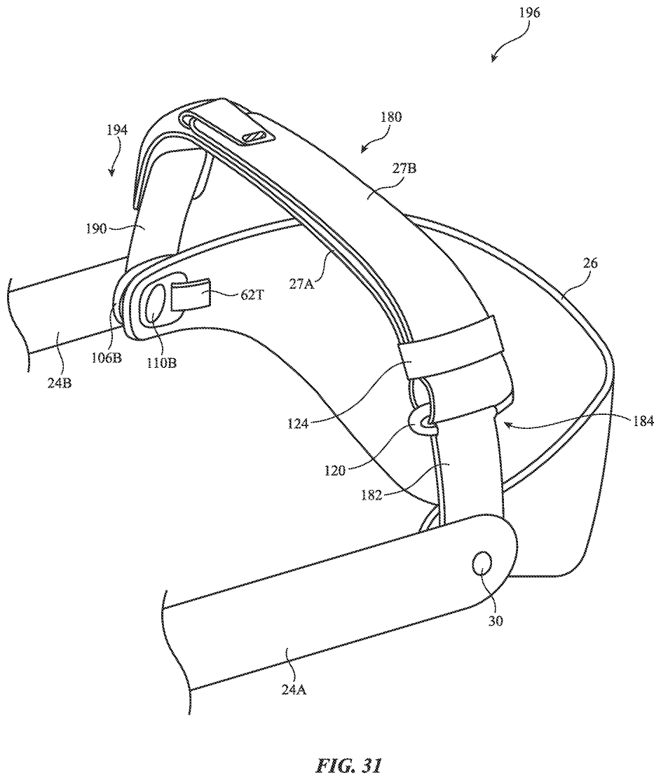

Post 110A may be formed on hair guard 106A and allow temple portion 184 to be attached to one or more additional headbands (e.g., lower headband 26 of FIG. 1) and/or to a portion of a head-mounted support housing (e.g., member 24 of FIG. 1). An illustrative view of temple portion 184 is shown in FIG. 30A.

As shown in FIG. 30A, temple portion 184 includes keeper loop 124, including portion 126, and temple webbing 182 in an integral structure. Additionally, temple portion 184 includes hair guard 106A. Therefore, single temple portion 184 may be used to couple headband 180 to additional headbands/head-mounted housing portions (through post 110A), attach to headband portions 27A and 27B (through temple webbing 182), and maintain headband portions 27A and 27B in a flat position on the head of the user (through keeper loop 124 and adjuster loop 120). Recess 184A may be included on post 110A so that an additional headband (e.g., lower headband 26 of FIG. 1) may be attached to post 110A, and latch 186A may be included on hair guard 106A to remove temple portion 184 from a support member (e.g., member 24 of FIG. 1), which may be attached within a recess on the rear of post 110A.

Returning to FIG. 29, temple portion 194 may be formed at a second side of headband 180, opposite temple portion 184. Temple portion 194 may include hair guard 106B and temple webbing 190 attached to hair guard 106B.

Post 110B may be formed on hair guard 106B and allow temple portion 194 to be attached to one or more additional headbands (e.g., lower headband 26 of FIG. 1). Additionally, recess 188 may be formed in the rear of post 110B, allowing temple portion 194 to attach to a portion of a head-mounted support housing (e.g., member 24 of FIG. 1). An illustrative view of temple portion 194 is shown in FIG. 30B.

As shown in FIG. 30B, temple portion 194 includes temple webbing 190 attached to hair guard 106B in a single structure. Temple webbing 190 may be attached to, or be a portion of, headband portion 192, which may be a portion of headband portion 27A and/or headband portion 27B (FIG. 29). Therefore, single temple portion 194 may be used to couple headband 180 to additional headbands/head-mounted housing portions (through post 110B) and attach to headband portions 27A and 27B (through temple webbing 190. Recess 184B may be included on post 110B so that an additional headband (e.g., lower headband 26 of FIG. 1) may be attached to post 110B, and latch 186B may be included on hair guard 106B to remove temple portion 194 from a support member (e.g., member 24 of FIG. 1), which may be attached within a recess on the rear of post 110B.

Returning to FIG. 29, portion 27A of headband 180 may extend from portion 192 (e.g., portion 27A may be integral with portion 192 and/or with temple webbing 190 of temple portion 194), through keeper loop 124 and adjuster loop 120, and may double-back as headband portion 27B. Double-backed portion 27B may have pull tab 168 at the end of doubled-back portion 27B. On the opposite surface of double-backed portion 27B, one or more hook and loop fasteners (e.g., hook and loop fasteners 150 of FIG. 26) may be attached to secure double-backed portion 27B in place after it is adjusted.

As discussed, the posts and recesses on temple portions 184 and 194 of headband 180 may allow headband 180 to be attached to one or more additional headbands and/or head-mounted support structures. An illustrative example is shown in FIG. 31.

As shown in FIG. 31, headband system 196 may include headband 180, lower headband 26, and members 24A and 24B of a head-mounted support structure. Headband 180 may be attached to members 24A and 24B at posts 30. In other words, members 24A and 24B may have posts that extend into recesses in headband 180 (e.g., recess 188B in hair guard 106B of FIG. 29 and a corresponding recess in hair guard 106A).

Headband 180 may be attached to lower headband 26 with posts 110A and 110B (FIGS. 28-29). In particular, as shown in FIG. 31, post 110B may extend through an opening in lower headband 26 and couple temple portion 194 to lower headband 26. IA corresponding post on other side of headband 180 (e.g., post 110A of FIGS. 28-29) may couple temple portion 184 to lower headband 26. In other words, headband 180, lower headband 26, and members 24A and 24B may be attached as shown in the example of FIG. 3. However, this attachment mechanism between headband 180, lower headband 26, and members 24A and 24B is merely illustrative. In general, any of the attachment mechanisms shown in FIGS. 2-19 may be used to couple headband 180, lower headband 26, and members 24A and 24B.

Release tab 62T may be used to release lower headband 26 from post 110B, and a corresponding release tab may be used to release lower headband 26 from temple portion 184. A latch (e.g., latch 62M of FIG. 4) may be used to attach lower headband 26 to posts 110A and 110B. In this way, lower headband 26 may be removably attached to headband 180.

Although not shown in FIG. 31 for simplicity, lower headband 26 may have one or more internal structures, such as internal bifurcated straps, that are adjustable (e.g., using a wheel to tighten and loosen the bifurcated straps) to adjust the size/fit of lower headband 26.

Members 24A and 24B may be attached to (or formed integrally with) a head-mounted device, such as head-mounted device 10 of FIG. 1.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A headband system operable with a head-mounted device, the headband system comprising:
a first headband having an opening;
a head-mounted device housing structure having a post configured to be received within the opening;
a latch having a latch member configured to move between an open position in which the latch member does not engage the post and a closed position in which the latch member engages the post and secures the first headband to the head-mounted device housing structure; and
a second headband coupled to the head-mounted device housing structure.

2. The headband system of claim 1, wherein the post is a first post, and the second headband comprises a second post that is configured to be attached to the first post.

3. The headband system of claim 2, wherein the second post is further configured to be received within the opening in the first headband with the first post.

4. The headband system of claim 1, wherein the post comprises a first magnet, the second headband comprises a second magnet, and the second headband is configured to be attached to the post magnetically.

5. The headband system of claim 1, wherein the second headband is configured to be clipped on to the head-mounted device housing structure.

6. The headband system of claim 5, wherein a portion of the second headband is configured to surround the post.

7. The headband system of claim 1, wherein the post comprises an additional opening, the second headband comprises a protruding portion, and the second headband is configured to be attached to the head-mounted device with the protruding portion inserted into the additional opening.

8. The headband system of claim 7, wherein the post comprises a first magnet, the protruding portion comprises a second magnet, and the protruding portion is configured to be attached to the post magnetically.

9. The headband system of claim 7, wherein the opening in the post and the protruding portion form a twist-to-lock system that is configured to couple the second headband to the post.

10. The headband system of claim 7, wherein the protruding portion comprises an additional latch that is configured to attach to a recess within the opening in the post.

11. The headband system of claim 1, wherein the opening is a first opening, the second headband comprises a second opening that is larger than the first opening, and the post is configured to pass through the second opening to attach the second headband between the first headband and the head-mounted device housing structure.

12. The headband system of claim 11, wherein the head-mounted device housing structure further comprises a pin, the second headband comprises an additional opening, and the pin is configured to be received in the additional opening.

13. The headband system of claim 11, wherein the second headband further comprises an elastomer ring that surrounds the second opening, and the elastomer ring is configured to contact the post when the second headband is coupled to the head-mounted device housing structure.

14. The headband system of claim 11, wherein the head-mounted device housing structure further comprises a compressible gasket, and the second headband is configured to contact the compressible gasket when the second headband is coupled to the head-mounted device housing structure.

15. The headband system of claim 1, wherein the post comprises an extendable magnet, the second headband comprises an additional opening with a stationary magnet, and the stationary magnet is configured to attract the extendable magnet into the additional opening to attach the second headband to the head-mounted device.

16. The headband system of claim 1, wherein the second headband is an overhead strap and is configured to be attached to the head-mounted device housing structure between the first headband and the head-mounted device housing structure.

17. The headband system of claim 1, wherein the second headband is an overhead strap, and the first headband is configured to be attached to the head-mounted device housing structure between the second headband and the head-mounted device housing structure.

18. The headband system of claim 1, further comprising:
a hair guard interposed between the first headband and the second headband.

19. The headband system of claim 18, wherein the hair guard comprises at least one contoured portion that has a first curvature that matches a second curvature of the first headband.

20. The headband system of claim 19, wherein the hair guard further comprises a gap filler in contact with a surface of the first headband.

21. The headband system of claim 19, wherein the hair guard further comprises an additional post configured to couple to the post of the head-mounted device housing structure and to the second headband.

22. A head-mounted device operable with first and second headbands, comprising:
a head-mounted device housing structure; and
a post coupled to the head-mounted device housing structure, wherein:
the post is configured to be received within an opening in the first headband; and
the second headband is configured to be attached to the post.

23. The head-mounted device of claim 22, wherein the post has a movable latch member configured to move between:
a retracted position that allows the first and second headbands to be detached from the head-mounted device housing structure; and
an extended position in which the movable latch member is received within a latch recess on a side of the opening and retains the first and second headbands on the post.

24. The head-mounted device of claim 22, wherein the post is a first post and is configured to be received within a second post on the second headband, and wherein the first and second posts are configured to be received within the opening in the first headband.

25. The head-mounted device of claim 22, wherein the opening is a first opening, and wherein the post is further configured to be received within a second opening in the second headband, with the second headband interposed between the head-mounted device housing structure and the first headband.

26. A head-mounted device headband system operable with a head-mounted device housing, wherein the head-mounted device housing has first and second protruding portions, wherein the head-mounted device headband system comprises:
a first headband having opposing ends with respective first and second openings that are respectively configured to receive the first and second protruding portions;
a first releasable latch configured to secure the first protruding portion within the first opening;
a second releasable latch configured to secure the second protruding portion within the second opening; and
a second headband having first and second opposing ends that are respectively configured to be attached to the first and second protruding portions.

27. The head-mounted device headband system of claim 26, further comprising:
first and second adjustment loops, wherein the first and second headbands comprise double-backed portions that respectively pass through the first and second adjustment loops.

28. The head-mounted device headband system of claim 27, further comprising:
first and second soft keeper loops, wherein the double-backed portions of the first and second headbands are respectively configured to pass through the first and second soft keeper loops.

29. The head-mounted device headband system of claim 28, further comprising:
first and second pull tabs respectively coupled to single surfaces of the double-backed portions of the first and second headbands; and
hook and loop fasteners coupled to opposing surfaces of the double-backed portions.

30. The head-mounted device headband system of claim 29, wherein the first and second headbands comprise fabric, the hook and loop fasteners are formed on substrates, and the substrates are embedded within the fabric.

31. The head-mounted device headband system of claim 26, wherein the first headband comprises a strap that includes woven fabric portion surrounded by a webbing, the webbing has rounded corners at an edge of the woven fabric portion, the webbing has a first portion and a second portion, and the first and second portions of the webbing meet at a seam that is invisible to a naked eye.

32. The head-mounted device headband system of claim 26, wherein the first headband comprises first and second temple portions, wherein the first temple portion comprises a first hair guard, the first opening on a first side of the first hair guard, and a first post on an opposing second side of the first hair guard, wherein the second temple portion comprises a second hair guard, the second opening on a first side of the second hair guard, and a second post on an opposing second side of the second hair guard, and wherein the second headband is configured to be attached to the first and second posts.

33. The head-mounted device headband system of claim 26, wherein the first headband comprises a temple portion having a temple webbing and a keeper loop in an integral structure.
